(19) United States
(12) Patent Application Publication
(10) Pub. No.: US 2014/0341376 A1
(43) Pub. Date: Nov. 20, 2014

(54) METHOD AND APPARATUS FOR AUTOMATICALLY OBTAINING DIGITAL CINEMA DECRYPTION KEYS

(71) Applicant: THOMSON LICENSING, Issy de Moulineaux (FR)

(72) Inventors: Nicholas Curtis Mitchell, Los Angeles, CA (US); William Gibbens Redmann, Glendale, CA (US)

(73) Assignee: THOMSON LICENSING a corporation

(21) Appl. No.: 14/360,815

(22) PCT Filed: Dec. 13, 2012
(86) PCT No.: PCT/US2012/069349

§ 371 Date: May 27, 2014

Related U.S. Application Data
(60) Provisional application No. 61/570,781, filed on Dec. 14, 2011.

(51) Int. Cl. H04N 7/167; H04L 9/30

(52) U.S. Cl. CPC H04N 7/1675; H04L 9/30; H04L 2209/24
USPC 380/201

(57) ABSTRACT

A method and system are disclosed for providing decryption key information in a digital cinema package. Information relating to at least the source of a decryption key is included in the digital cinema package.

### CROSS-REFERENCE TO OTHER APPLICATIONS

This application claims priority to U.S. Provisional Application Ser. No. 61/570,781, “METHOD AND APPARATUS FOR AUTOMATICALLY OBTAINING DIGITAL CINEMA DECRYPTION KEYS” filed on Dec. 14, 2011, which is herein incorporated by reference in its entirety.

### TECHNICAL FIELD

This invention relates to a method and apparatus for obtaining decryption keys for decrypting digital cinema content.

### BACKGROUND

Most studios produce digital cinema features or content that are encrypted, requiring decryption keys to be obtained by an exhibitor prior to showing. The keys and the digital cinema feature are never distributed together. The features are often provided by a studio to a third party distribution agent, who may or may not be the agent providing the keys to the exhibitor. Since the distribution agent (which may be the key providing agent) is independent of the studio, there may be confusion as to who to contact as show time nears and keys have not been obtained.

Generally, the decryption keys required for exhibition of the digital cinema content are proactively sent by the key distributor to appropriate exhibitors. When this process fails, or in case of a last-minute agreement by an exhibitor to show a feature, exhibition personnel will contact one or more key distributors to determine which entity will be able to provide the keys. However, if the identity of the key distributor is not known by the exhibitor, then exhibition personnel must determine the correct distributor by asking other distributors or the studio. Such a process has the drawback of consuming a substantial amount of exhibition and distributor or studio resources, and often results in a dark screen situation, where the keys do not arrive in time for the exhibition. When the last-minute key acquisition works, a key can be found (or created) and transmitted within) ten minutes, but overall, the present practice is unreliable and stressful for all involved.

Certain aspects of a key distribution system are taught in a commonly-assigned patent application US2009/0196426 by Walker et al., entitled “Method and Apparatus for Key Distribution for Secure Digital Cinema Presentations,” which is herein incorporated by reference in its entirety. In Walker et al., a predetermined source for key distribution is presumed or made known to the exhibitors. However, an ongoing need exists for alternative approaches of providing information regarding sources of decrypting keys.

### SUMMARY OF THE INVENTION

The present invention relates to a method and system of providing information relating to at least one source of decryption keys for encrypted features in a digital cinema package (DCP) so that an exhibitor can readily identify the key distribution entity in case the decryption keys are not received. The DCP provides, for each encrypted feature or composition, one or more references to sources of decryption keys. The key source references or information are maintained by a digital cinema server or theater management system in association with the encrypted features such that when keys need to be obtained for feature presentation, the key source information and decryption keys can be automatically retrievable. The key source information can be included in different formats in various files consistent with existing standards, or in a new key source file not compliant with existing industry standards.

One embodiment provides a digital cinema package, which includes key source information relating to at least one source of a decryption key for decrypting content in the digital cinema package.

Another embodiment relates to a method of providing decryption key information for digital cinema content. The method includes providing key source information relating to at least one source of a decryption key for decrypting content in a digital cinema package, with the key source information being provided in the digital cinema package.

### BRIEF DESCRIPTION OF THE DRAWINGS

The teachings of the present invention can be readily understood by considering the following detailed description in conjunction with the accompanying drawings, in which:

FIG. 1 is a block diagram showing a system for providing digital cinema decryption keys according to one embodiment of the present invention;

FIG. 2 is a block diagram showing details of a key provider system;

FIG. 3 is an example of portions of an asset map file of the prior art;

FIG. 4 is an example of portions of an asset map file according to one embodiment of the present invention, identifying sources for keys in the annotation text for a CPL;

FIG. 5 is another example of portions of an asset map file according to one embodiment of the present invention, identifying sources for keys in a comment field associated with the asset element for a CPL;

FIG. 6 is yet another example of portions of an asset map file according to one embodiment of the present invention, identifying sources in a specific XML tag associated with the asset element for a CPL;

FIG. 7 illustrates one embodiment of obtaining decryption keys for an encrypted feature based on key source information in a digital cinema package;

FIG. 8 illustrates one embodiment of tracking key sources associated with an encrypted feature, and obtaining decryption keys from a key source to play the feature; and

FIG. 9 illustrates another embodiment of providing an encrypted feature and associated key sources.

To facilitate understanding, identical reference numerals have been used, where possible, to designate identical elements that are common to the figures.

### DETAILED DESCRIPTION

The Society of Motion Picture and Television Engineers (SMPTE) of White Plains, N.Y., has produced and publishes a number of standards to promote the success of digital cinema. The following SMPTE standards documents contain information relating to packaging and exhibiting digital cinema:

ST 0429-3-2007 D-Cinema packaging—Sound and Picture Track File,

ST 0429-5-2009 D-Cinema Packaging—Timed Text Track File,

ST 0429-7-2006 D-Cinema Packaging—Composition Playlist,

ST 0429-8-2007 D-Cinema Packaging Packing List,

ST 0429-9-2007 D-Cinema Packaging—Asset Mapping and File Segmentation,

ST 0429-2-2009 D-Cinema Packaging DCP Operational Constraints,

ST 0429-6-2006 D-Cinema Packaging—MXF Track File Essence Encryption,

ST 0430-1-2006 D-Cinema Operations—Key Delivery Message, and

ST 0430-2-2006 D-Cinema Operations—Digital Certificate.

To help with better understanding of the present invention, some background regarding digital cinema packaging is given below. A digital cinema package (DCP) typically includes many components such as asset track files, audio track files, a composition playlist (CPL), a key delivery message (KDM), a packing list (PKL), and an asset map file. While the discussion herein is presented in terms of the SMPTE standards listed above, other de facto standards used in the industry, such as the MPEG Interop Packaging Specification described by the MPEG Interop Initiative, have similar components that are similarly adaptable for use in the present invention.

Asset track files contain a single type of picture, audio, or text asset for at least a reel of a feature. (In digital cinema, a reel is at least one-second of presentation, commonly up to about twenty minutes, but can be more.) Asset track files are standardized XML files that contain other structural and descriptive information, besides the picture, audio, subtitle, or caption assets. Picture track files contain one discrete image for at least each frame of a movie reel, or two images for each frame if the movie is in stereoscopic 3D. Audio track files contain 48,000 (and in some cases, 96,000) audio samples per second, for each channel of audio for at least the duration of the movie reel. This is also the case for alternative language track files. Captions and some subtitles are provided as text in a track file (other subtitle files comprise pictures of text), and data indicating the appropriate color for the text and when, where, and for how long the text (or pictures of text) should appear. Each track file has a globally unique identification number (GUID) so that it can be unambiguously referenced.

For an encrypted feature or presentation, the data representing the picture, audio, or subtitle and caption assets within the track files are encrypted (hut the metadata describing the data and the XML structures containing the data are not encrypted), thus limiting the threat of piracy. A different key is used to encrypt each of the asset track files, and these same keys are needed to decrypt the assets for playout.

The composition playlist, or CPL file, is a standardized XML data structure that identifies the various asset track files and their order necessary to provide a coherent presentation. For each of the one or more reels in a feature, the CPL precisely identifies the picture, audio, and any alternative language, subtitle, or caption track files using their corresponding GUIDs, and further includes entry and exit points within those tracks to provide exact synchronization among the different assets (e.g., so that audio is in synchronization with the picture, and subtitles appear precisely when characters speak).

The CPL, which is not encrypted (in the current standards, only the asset track files referenced by the CPL, such as pictures, sound tracks, and so on, might be encrypted), usually has a secure, digital signature provided by the creating authority, typically a studio or post-production packaging house authorized by the studio. This signature assures the exhibitor and the studio that the composition expressed in the CPL is authentic and will be shown exactly as intended. Each distinct CPL has its own globally unique identification number (GUID).

With each asset track file of an encrypted feature being encrypted with a different key, the multiple decryption keys required to play the feature represented by a particular CPL are contained in a key delivery message, or KDM. According to the above standards, the KDM is another XML file. Even though a KDM is in fact a collection of multiple keys in a secure wrapper, within the digital cinema industry, KDMs are sometimes referred to as a “key” or “keys”. Note that the actual cryptographic keys for encrypting and decrypting individual asset track files are not sent bare (without a secure wrapper) or transmitted by themselves.

In the context of the present invention, expressions such as requests for decryption keys or KDMs, or sources of decryption keys or KDMs are also meant to include requests for general messages for providing key delivery, or sources of key delivery messages, whether these messages conform to specific industry standards or not.

A KDM is created to be associated with exactly one digital cinema server or any other trusted device, and one CPL. The digital cinema server is identified by a cryptographically secure thumbprint (commonly called the domain name qualifier “DN Qualifier”) of a cryptographic certificate associated with only the digital cinema server, but potentially another identification uniquely associated with the device's digital certificate, and the CPL is identified by its GUID. The KDM contains all of the keys necessary to decrypt the assets in the track files referenced by the CPL, but each key is itself encrypted, so that only the single, designated device (e.g., the particular, targeted digital cinema server) can access them. Furthermore, the KDM includes start and end dates indicating to the digital cinema server the interval or date range when the designated device is allowed to decrypt and exhibit the referenced composition. The digital cinema server is entrusted to respect these restrictions, and the manufacturers of such servers assure that this is the case in the form of the manufacturer's secure digital signature that relies on a digital certificate of the manufacturer. Lastly, the KDM has a secure, digital signature by the key-making entity (usually, either the key distributor or a separate, authorized key maker), to ensure that no one has tampered with the KDM.

The packing list, or PKL file, lists each of the track files and CPLs in a package, including their exact size. The PKL file is also identified by its own globally unique identification number (GUID) and usually has a secure digital signature provided by the studio or feature distributor.

Finally, an asset map file is provided that lists each track file, CPL, and PKL by the corresponding GUID, and describes where each element of the digital cinema package is located as a file.

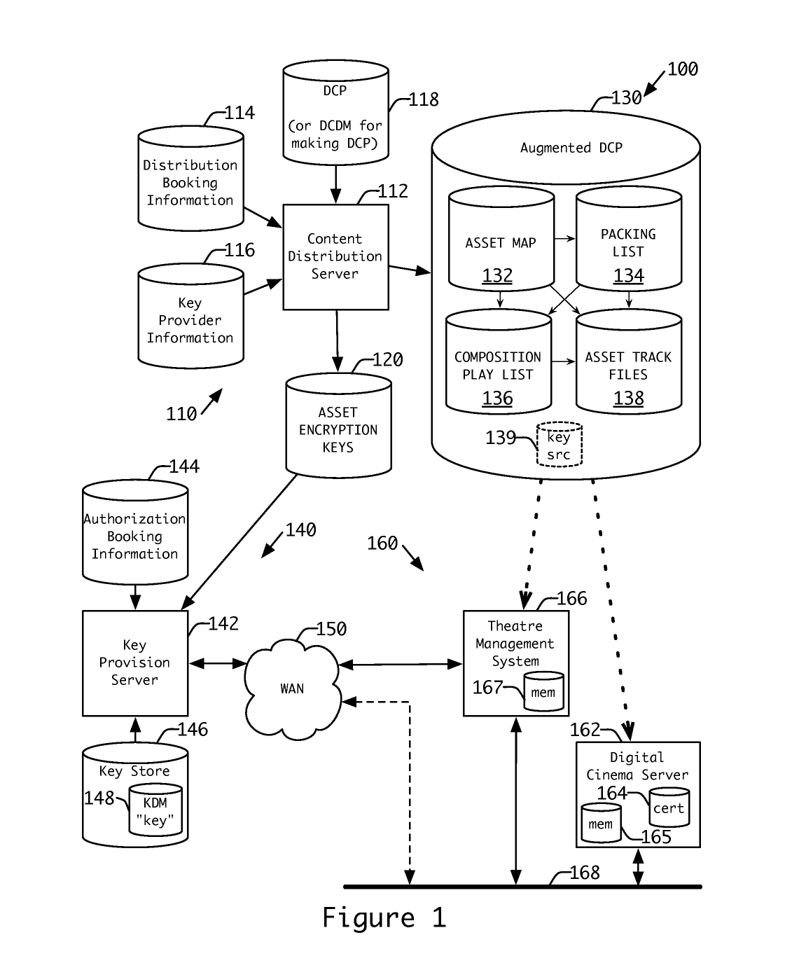

FIG. 1 shows a system 100 for illustrating distribution of decryption keys for digital cinema content according to one embodiment of the present invention. In this example, key provider or source information is provided in a digital cinema package such as an augmented or enhanced DCP 130, which has been modified from a conventional DCP. System 100 includes a content distribution system 110, a key provider system 140 and a theater or exhibitor system 160.

The content distribution system 110 includes a content distribution server 112, which modifies a conventional digital cinema package (DCP 118) by incorporating key provider or source information to produce an augmented or enhanced DCP 130. Based on the key provider information, the decryption keys can be obtained.

The key provider system 140 includes a key provision server 142, which generates key delivery messages based on asset encryption keys and authorization booking information.

The theater or exhibitor system 160 requests decryption keys from one or more key providers based on key provider information in the augmented DCPs received.

These component systems are further discussed below.

Content distribution system 110 receives a complete DCP 118, or a Digital Cinema Distribution Master (DCDM) representing all the information and assets needed to create a complete DCP. Transforming a DCDM into a DCP is a well-known process currently requiring manual intervention, e.g., as performed using the suite of software tools marketed as the Wailua D-Cinema Mastering System by CineCert, LLC of Burbank, Calif.

Under conventional practice, the DCP 118 is typically distributed to exhibition theaters 160 based on distribution booking information 114, which lists exhibition theaters that are booked or authorized to show the feature presentation.

According to the present invention, a different DCP 130 is distributed to theater 160 instead. DCP 130 is created by modifying a conventional DCP to include information regarding at least a provider of decryption keys, as further discussed below. The content distribution system 110 manages DCP distribution, which can be done by different means, including sending the DCP via satellite (not shown) or recording the DCP on a hard disk drive (not shown) and shipped to various exhibitors or theaters 160.

If distribution system 110 is entrusted with any encryption of the asset track files, then it will be in possession of the keys needed to decrypt those assets. For each feature (each described by a CPL 136), distribution system 110 must provide the asset encryption keys 120 (also used for asset track file decryption) to each authorized key provision system 140 listed in the key provider information 116. In instances where the asset track files in the DCP 118 as provided to content distribution server 112 are already encrypted, asset encryption keys 120 may be provided to key provision systems 140 by the studio or another party. This arrangement can be used to increase security, because the entity tasked with distributing content is not able to also distribute keys for that content.

Key provision systems in general are known, for example, as taught in commonly-assigned patent applications: US2009/0196426 by Walker et al, entitled “Method and Apparatus for Key Distribution for Secure Digital Cinema Presentations” and US2008/0137869, by Arnaud Robert, titled “Key Management System for Digital Cinema,” both of which are herein incorporated by reference in their entirety.

According to the present invention, the key provision system 140 is referenced by, or identified in, the key source information or data added to the enhanced DCP 130, and is responsive to requests for keys sent by exhibitors or other authorized entities. In some embodiments, the requests are formulated according to the key source information in the enhanced DCP, while in other embodiments, the requests can be formulated according to a convention established elsewhere.

The asset encryption keys 120 are sent to the key provision system 140 in accordance with the key provider information 116. Note that the earlier that the asset encryption keys 120 are provided to a key provision system 140, the earlier that the system 140 can begin generation of the KDMs 148 for digital cinema servers 162. KDMs 148 may have been pre-generated by a key provider or a key provision server in accordance with authorization booking information 144 and other policies (not shown), e.g., a policy in which a specific content owner might constrain all keys to have a period of validity not to exceed a particular duration. KDMs generated in advance of any requests by the exhibitors can be stored in key store 146 for subsequent retrieval upon request or for bulk distribution. For many implementations, this results in a lower peak computational demand than requiring KDMs to be generated upon demand and returned on the fly.

In the present invention, content distribution system 110 creates or modifies DCPs 118 by including key provider information 116 concerning one or more key provider systems 140, thus producing an augmented or modified DCP 130 for distribution to one or more exhibition theaters 160. The content distribution system 110 includes at least a content distribution server 112 operatively coupled to one or more distribution channels or mechanisms to exhibitor facilities (not shown), e,g., satellites, broadband, disk replicators and courier delivery, as well as a suite of software tools, e.g., the CineCert Wailua tools. The augmented or modified DCP 130 includes additional key provider information 116 obtained from the studio (content owner) or other authority.

Key provider information 116 identifies at least one key provider system 140 that is authorized to generate and/or distribute KDMs 148 for individual CPLs 136 in the DCP 130 having encrypted content.

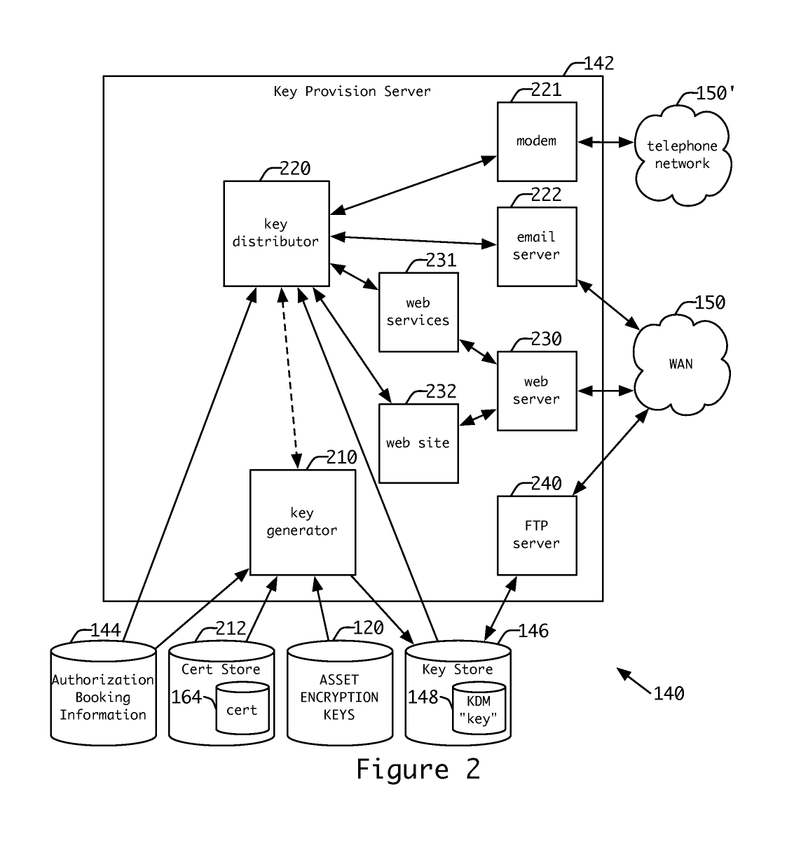

Key provider information 116 also includes access information identifying one or more methods to contact each key provider. One example method for contacting key provider system 140 is to contact key provision server 142 through a communication channel, for example, comprising wide area network (WAN) 150, which may in turn include the Internet, as shown for TMS 166. This communication channel may also include intermediate LAN 168, as for digital cinema server 162. Such information may be expressed as a URL, for example indicating use of hypertext transfer protocol (i.e., http://) or other. When contacting key provision server to request a key for a particular feature described by CPL 136 for playout on digital cinema server 162, the digital certificate 164 or the corresponding distinguished name qualifier (DN Qualifier) is provided along with the unique identifier of CPL 136, and optionally other information (e.g., start date and duration). Parameters to the request such as the unique identifier of the CPL 136 and the DN Qualifier for the digital cinema server 162 may be substituted into the URL in positions indicated by a convention for an HTTP Get operation, as is commonly done in interfaces using the well known Representational State Transfer (RESTful) architecture. In other embodiments, the parameters may be submitted in a document, as in an HTTP Post operation, as is commonly found in interfaces using the well known Simple Object Access Protocol (SOAP). This and other example ways to contact key provider system 140 and request keys are further discussed in conjunction with FIG. 2 below.

At theater 160, information relating to key provider system is obtained from the augmented DCP 130 by individual digital cinema servers 162 (also known as screen management servers, or SMS) or a management system that manages multiple cinema servers such as theater management system (TMS) 166 acting on behalf of digital cinema server(s) 162. One or more requests can be sent by the digital cinema server 162 or theater management system 166 based on information regarding the sources of KDMs and manner of obtaining them. For example, a request can be made to obtain a KDM associated with one CPL for a particular digital cinema server 162. Alternatively, instead of sending many separate requests for KDMs, a single request can be made by a digital cinema server 162 or theater management system 166 (on behalf of one or more digital cinema servers 162) to obtain KDMs for several (or all) respective CPLs in a DCP. The DCP can be identified by the asset map's UUID, the PKL's UUID or other relevant information. For example, information necessary for communicating with key provider system 141) regarding the KDM 148 can be provided in the asset map 132 in the augmented DCP. The KDM 148, which is associated with both a specific digital cinema server 162 and CPL 136, is necessary for decrypting and showing the feature described in CPL 136 by the digital cinema server 162 that is authorized by authorization hooking information 144.

Key provider information 116 can be incorporated into any of the files relating to encrypted content in a DCP 130, e.g., asset map 132, packing list (PKL) 134, composition play list (CPL) 136, and/or asset track files 138, or in one or more additional files. These additional files can include a special file 139, listing at least one key provider 140, e.g., a text file “KeyProvider.xml” dedicated to this function and not otherwise normally present, or other standard files subsequently defined, or currently defined but not specifically mentioned here (such as a subtitle track file, which is one type of asset track file 138).

Since asset track files, CPL and PKL are digitally signed to remain secure against tampering, if one or more of these files are amended or modified to identify appropriate key providing systems 140, the amended files will have to be re-signed under the authority of the content distribution system 110, instead of the original creator of DCP 118. Thus, it may be desirable, or as a matter of policy or standards, to provide a modified DCP in a different way, in order to avoid the need for modifying and re-signing files under the authority of the content distribution system 110.

Furthermore, if asset track files 138 are re-packaged from the original files in DCP 118, their size and WAD would change, which would require all the CPLs 136, PKL 134, and asset map 132 to be updated accordingly. Similarly, if CPLs 136 and/or PKL 134 are re-packaged from the respective original files in DCP 118, their respective sizes and GUIDs would change. For re-packaged PKL 134, the asset map 132 has to be modified as well, whereas for re-packaged CPLs, both the asset map 132 and PKL 134 will have to be modified.

In another embodiment, asset map 132, which refers to each of PKL 134, associated CPLs 136, and associated encrypted asset track files 138, may be amended or modified to identify appropriate key providing systems 140. Unlike asset track files, CPLs or PKLs, asset map 132 is not digitally signed. Instead, it is an informational utility to help systems locate the files corresponding to specific GUID references. That is, CPL file 1136 references asset track files 138 by GUID, and asset map 132 provides an index identifying that a particular GUID corresponds to a particular named file (in a file system based implementation of DCP 130). Thus, one advantage of this implementation is that the content distribution system 110 is not required to re-sign any of the files, and all security and certification authority remains with the original entity packaging the DCP 118.

In another embodiment, a new type of file, e.g., a key source file 139, is added to augmented or enhanced DCP 130. The key source file would contain information about the appropriate key providing systems 140 and the CPLs to which they apply.

In yet another embodiment, any of theater management system (TMS) 166 and digital cinema servers 162 of exhibition theater 160 may choose to record and store in long-term memory (e.g., memories 165 and 167, respectively) at least the identifications of appropriate key providing systems 140 encountered based on key source information from enhanced DCPs, though duplicates may be ignored. For example, a list of key providers can be included in every DCP distribution, regardless of Whether the content is encrypted or not. The list is stored in memory with a predetermined expiration period, e.g., a month or so. Thus, the list is updated on an ongoing or continuing basis as new DCPs are received. By storing key providing system identities in this way, the theater management system (TMS) and digital cinema servers of theater 160 quickly learn of multiple key providing systems. The TMS and servers can be configured such that, even when a DCP 118 of the prior art is received at theater 160, an attempt to obtain keys from previously learned systems (i.e., one or more previously known key provider systems) can be made, even though they are not identified in the received DCP 118.

For example, the search for the key source can begin with key provision servers that have previously been used by the studio that issued or produced the content. The search can be done based on at least one established rule, for example, by first contacting the most recently used servers, or the most commonly used servers, among others. Although this approach is not as efficient as it could be, it is still more preferable than requiring human intervention. However, if the theater fails to obtain the proper key provider from stored information, human intervention can be requested.

FIG. 2 is a block diagram illustrating one embodiment of the present invention, showing details of a key provider system 140, which includes a key provision server 142 with a key distributor 220, key generator 210, and other hardware and software components (e.g., web server 230, file transfer protocol (FTP) server 240, among others). The key provision server 142 can be configured in different manners, including a processor-memory-input-output architecture, which can be implemented as a single server, or as a cluster of servers interconnected by communication lines, or on a network. Each module or component of key provision server 142 has one or more programs stored in memory for execution by one or more processors (not shown) that may be associated with a specific module, or shared with other modules.

The key generator 210 and key distributor 220 can be configured as one or more servers. An example of a key generator 210 is the Waimea D-Cinema Key Management Server, manufactured by CineCert, LLC (previously mentioned). In one embodiment, the key generator and distributor each includes at least one server, which can operate either independently or interactively with each other. Multiple servers can be used for improved throughput and redundancy. The web services 231, web site 232, and respective servers 222, 230, 240 for email, web, and FTP can have individual software modules running on the key distributor 220, or can be distributed across multiple physical servers, e,g., to distribute load and to provide fault tolerance.

Key generator 210, for security reasons, should require digital certificates 164 (e.g., public keys) for corresponding digital cinema server 162, obtained from and/or signed by a trustworthy source, to be pre-loaded into certificate store 212. Key generator 210 reads authorization booking information 144 (provided, for example, by a studio) from a memory and generates KDMs 148 using asset encryption keys 120 corresponding to the CPLs 136 booked to run on digital cinema server 162. The KDMs contain start and end date information from the authorization booking information 144. In order to generate KDMs 148 for a particular digital cinema server 162, the key generator uses the public key presented in the digital certificate 164 of digital cinema server 162, typically found in association with the secure thumbprint (DN qualifier) of the certificate 164 to encrypt the asset encryption keys 120. Once the KDM 148 is generated, it may be stored in key store 146 for later recall and distribution, or used (distributed) immediately.

Key distributor 220 can present various interfaces for outside requests for KDMs. For example, a modem 221 can interact with exhibitor systems or theaters 160 via a connection with telephone network 150′.

Email server 222 can be used to send one or more KDMs to the email accounts of human managers and projectionists, or to automatic mailboxes (not shown) running on exhibitor systems 160. The KDMs themselves can be included as attachments singly, or as a .zip or .tar archive.

Web server 230, whose address is provided in the key provider information and included in the DCP 130, can be accessed by a theater for requesting KDMs. It can respond to HTTP requests by presenting either or both web services 231 and web site 232. Web site 232 may present a usable human interface, and/or accept parameterized URLs to make requests for keys. For example, an HTTP query of the form:

http://www.technicolor.com/keyRequest?CPL_ID=$CPL_GUID&SMS_ID=$DNQ

can be used with the variables $CPL_GUID and $DNQ replaced by the unique identifiers of the CPL 136 of interest and the domain-name qualifier (i.e., thumbprint of the digital certificate 164) corresponding to the digital cinema server 162 of for which keys are sought.

Web services 231 can be used to provide services to other automated systems (e.g., digital cinema server 162 or theatre management system 166). In an alternative embodiment, the same provision of services to automated systems may be made using dedicated applications and protocols over a socket or secure-socket layer interface.

In some embodiments, for example, where key store 146 is organized so that all KDMs 148 for a specific digital cinema server 162 or for all digital cinema servers under the charge of a theater management system 166, are hierarchically arranged in appropriate subdirectories, a login to a file transfer protocol (FTP) server 240 would return a directory containing all appropriate and current or upcoming KDMs, either as the top level directory, or in subdirectories thereof.

The key provision server 142 may support one or more interfaces 221, 222, 230, and 240, and the key distributor 220 requires access to key store 146 to perform its function. Whether or not key provision server 142 includes a key generator 210 is a design choice.

Generally, key generator 210 operates asynchronously and in advance of key requests received by key distributor 220. For example, when new authorization booking information is received, key generator 210 can proceed to generate keys by using the previously loaded certificates 164 in certificate store 212 and asset encryption keys 120, with the generated KDMs being stored in key store 146. Flow far in advance of the feature start date (supplied in the booking information and copied into the KDM) a KDM might be made available to an exhibitor system or theater 160 (whether or not it has already been generated and placed in key store 146) is a matter of policy that may be determined by the operator of the key provision system 140, the authorization booking information 144, or a policy of the content owner.

In an alternative embodiment, KDMs 148 may be generated just in time, or dynamically based on interactions with key distributor, in response to requests received by key distributor 220. However, in this case, key generator 210 must be able to keep up with expected peak request rates.

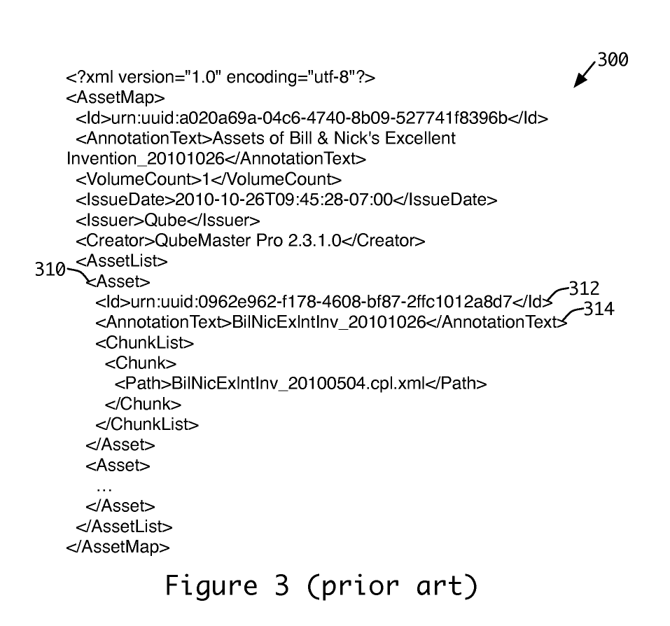

FIG. 3 shows an example asset map 300 of the prior art, which is in the form of an XML file. The <AssetList> element of asset map 300 enumerates one or more <Asset> elements, representing all the assets for a DCP 118. Example asset element 310 relates to one CPL in DCP 118. Asset element 310 includes <Id> element 312, which identifies one of the assets by its GUID, and an <AnnotationText> element 314, which includes human-readable text describing the specific asset. Also included in asset element 310 are instructions for where to find the asset, which in these examples is a path to the appropriate file (this latter portion not being altered in the present invention).

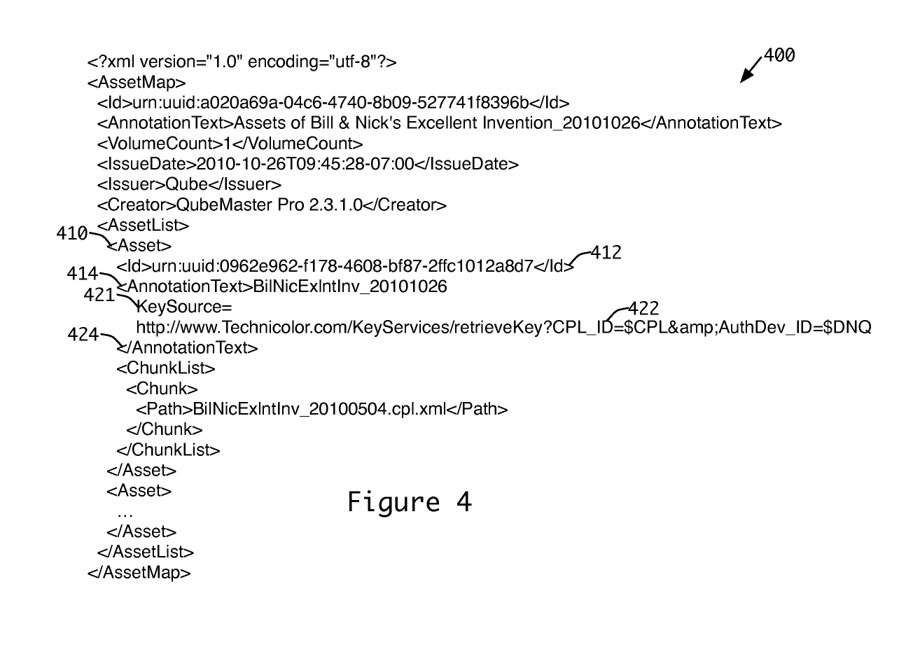

FIG. 4 shows an example of an asset map 400 of the present invention, which conforms to the schemas for prior art asset maps. In this embodiment, <Asset> element 410 corresponding to 310 contains an <Id> element 412, similar to <Id> 312 in <Asset> 310. However, asset 410 is augmented insofar as <AnnotationText> element 414, corresponding to <AnnotationText> element 314, includes not only the original, human readable description of the asset, but also key source identifier 421 (i.e., the phrase “KeySource=”) to indicate that <AnnotationText> 414 includes key source indication 422 of where and how to obtain keys (in this example, a URL with replaceable parameters $CPL and $DNQ). Element 414 is bounded by closing tag 424.

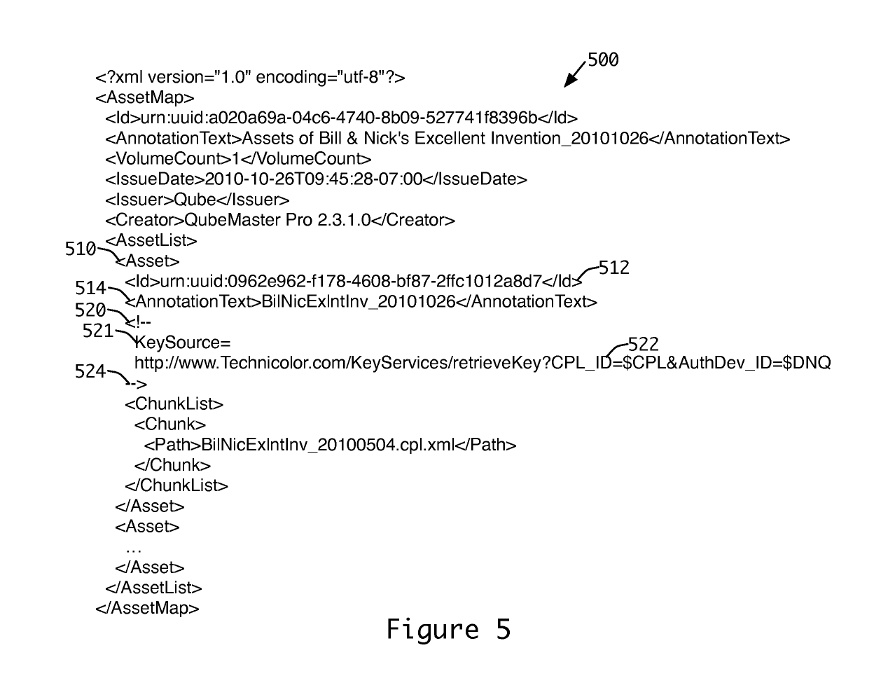

FIG. 5 shows another example of an asset map 500 of the present invention, which conforms to the schemas for prior art asset maps. In this embodiment, <Asset> element 510 includes <Id> 512 and <AnnotationText> 514 corresponding to 310, 312 and 314, respectively. However, asset 510 is augmented insofar as a comment 520 has been added that includes a key source identifier 521 (similar to 421) and key source indication 522 (similar to 422). The comment element is bounded by closing tag 524. Those skilled in the art will recognize that the comment element might be positioned at any of many locations within asset map 500.

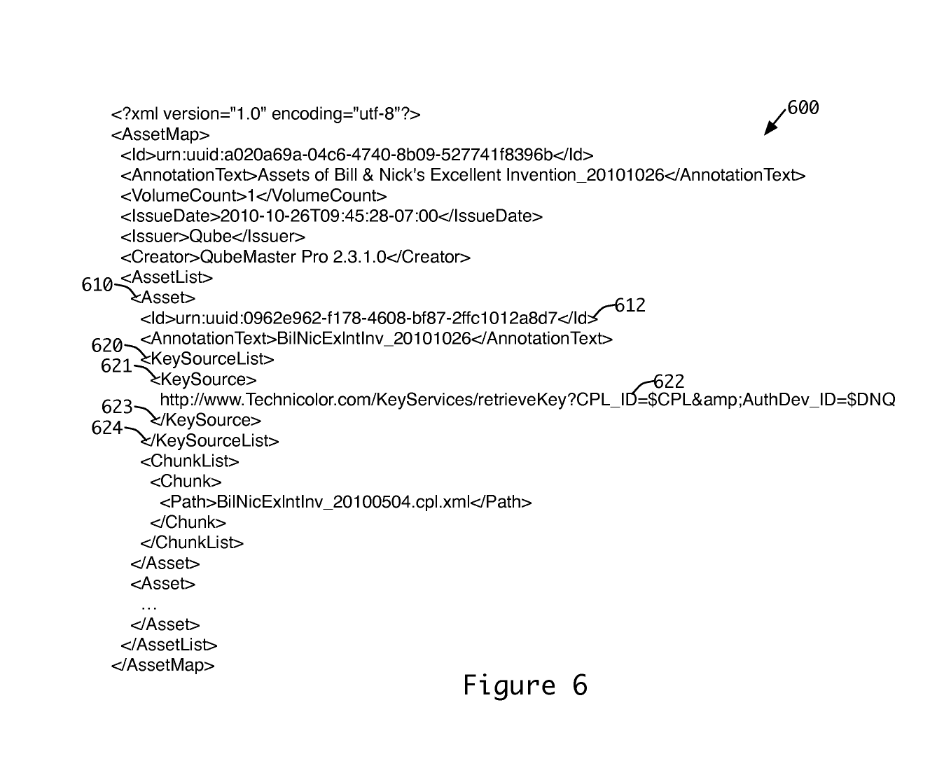

FIG. 6 shows another example of an asset map 600 of the present invention. However, unlike asset maps 400 and 500, asset map 600 does not conform to the schemas for prior art asset maps because new elements have been added, which are not acceptable under schemas for prior art asset maps. In this embodiment, <Asset> element 610 includes <Id> 612 and <AnnotationText> 614 corresponding to 310, 312 and 314, respectively. However, asset 610 is augmented insofar as a <KeySourceList> element 620 (with closing tag 624) is introduced, containing one or more <KeySource> elements 621 (having closing tag 623). Each <KeySource> element 621 (only one shown in asset map 600) provides key source indication 622 (similar to key source indications 422, 522). Those skilled in the art may consider other workable locations within asset map 600 that would be suitable for the placement of a <KeySource> element like 621.

Compared to asset maps 400 and 500, asset map 600 is the clearer and proper way for introducing a key source indication. However, asset map 600 requires an update to existing standards and would not be interoperable with systems adhering to the current standards. For this reason, an augmentation such as those shown in asset maps 400 or 500 may be used to practice the invention until such time as asset map 600 or the like is widely supported.

As mentioned above, similar changes might be made to other components of any conventional DCP (e.g., DCP 118), to produce augmented DCP 130. For example, the key source indication information (in the style of 422, 522, 622) might be added to PKL 134, CPL 136, or even asset track files 138, instead of asset map 132, with corresponding changes in one or more other files as described above, in order to produce a coherent, valid DCP 130.

In an alternative embodiment, instead of key source indicators 422, 522, 622 comprising an HTTP URL for a web server 230, as shown in FIGS. 4-6, the key source indicators can comprise a URL to an FTP site 240:

ftp://www.technicolor.com/keyRequest/$DNQ

in which the variable $DNQ can be replaced by the thumbprint of the certificate 164 (or other shared identifier for the exhibitor systems) by theater management system 166 or digital cinema server 162 before accessing, or:

ftp:$DNQ@www.technicolor.com/keyRequest/

where the login credentials provided by the theater management system 166 or digital cinema server 162 would begin the FTP session on FTP server 240, in a user directory within key store 146 corresponding to that exhibition system.

In still another embodiment, the key source indicator, still as a URL, can identify an email server:

mailto://keyRequest@technicolor.com? subject=$CPL&body=$DNQ

from which an interpreting component within exhibitor system 160 can compose a valid email message directed at email server 222, including an appropriate return email address. In an alternative embodiment, the return email address can be looked up by key distributor 220 in a database (not shown) associating a specific digital cinema server 162 or theater management system 166 with one or more email addresses, which minimizes the opportunity for fraud, since the email can only be sent to previously authorized recipients.

In still another alternative embodiment, the same key source indicator can be used by an operator to request keys by manually composing an email message using the appropriate subject and body values.

If a connection through modem 221 is appropriate, one or more phone numbers can be listed, for example, as described in “The tel URI for Telephone Numbers”, RFC 3966, December 2004 published by the Internet Society, Geneva, Switzerland.

tel: 1-800-993-4567: phone-context=+1

after which a predetermined connection protocol (e.g., PPP, SLIP, etc.) can be exercised.

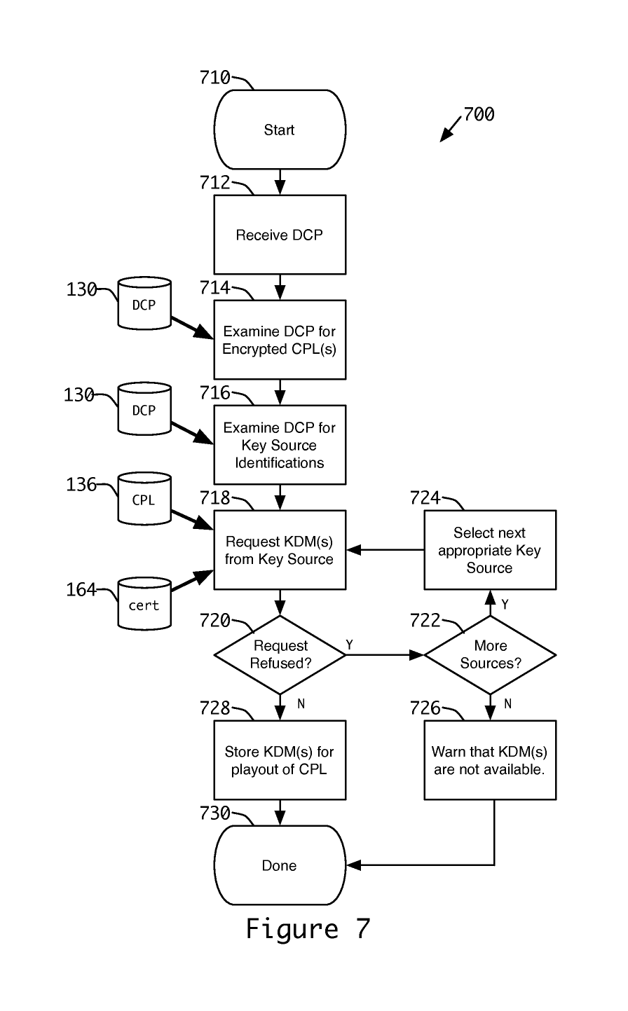

FIG. 7 shows a process 700 for acquiring decryption keys in accordance with the present invention. At step 710, an exhibitor system such as theater management system 166 or digital cinema server 162 is ready to ingest a DCP 130.

At step 712, the DCP 130 is received by the exhibitor system 160. For example, the DCP 130 can be transmitted via satellite communication link to a satellite receiver and recorded to memory at the exhibitor premise. Alternatively, a hard disk drive containing the DCP 130 can be shipped to the exhibitor premise.

At step 714, DCP 130 is examined for encrypted CPLs 136 of interest, i.e., CPLs for which decryption keys are to be requested. For each encrypted CPL 136 of interest, its unique identifier, which may be obtained from either asset map file 132, packing list 134, or CPL 136, is noted. At step 716, DCP 130 is examined for one or more key source identifications, such as those described in conjunction with FIGS. 4-6 in asset map 132, or in other files (e,g., packing list 134, key source file 139) within DCP 130, as proposed above as various alternative embodiments. Key source identifications relevant to the CPLs of interest are noted, including any constraints (none shown) as to which CPLs might be supported by individual key sources. In an alternative embodiment, instead of noting the unique identifiers of all CPLs of interest, a single identifier associated with the DCP 130, e.g., for the packing list (PKL) 134 or asset map 132, can be noted for use in retrieving KDMs for all the encrypted CPLs in a single request.

At step 718, a request for decryption keys or KDMs is made to one of the key sources identified at step 716. The request includes the unique identifier from at least one encrypted CPL 136 and the thumbprint of digital certificate 164 (e.g., the distinguished name qualifier) for digital cinema server 162, or some other unique identification indicating a specific digital cinema server 162 for which CPL decryption keys or KDMs are sought. Alternatively, a unique identifier associated with the DCP 130 can be used in requesting the decrypting keys or KDMs for all the CPLs of the DCP.

At step 720, a determination is made regarding the status of the key request. If it is determined that the request for keys has not been refused, then at step 728, the KDM received at the theater is stored locally for use by digital cinema server 162 when CPL 136 is scheduled (or manually triggered) to play. Key acquisition process 700 concludes at step 730.

If the request for any KDM is refused, as determined by the theater 160 at step 720, then processing continues at step 722 to determine whether there are more sources (key provider systems 140) to be tried for the desired key. If so, then at step 724, the next appropriate key source 140 is selected, and the process iterates back at step 718.

However, at step 722, if the system determines that there are no more sources for keys, then at step 726, the system warns that keys cannot be obtained.

A key request may be unsuccessful for a variety of reasons. For example, key provider system 140 may refuse the request because of one or more problems:

a) CPL not recognized (system 140 has no corresponding asset encryption keys 120),

b) SMS not recognized (system 140 has no corresponding certificate 148),

c) KDM not yet available (response could indicate when keys can be obtained),

d) KDM no longer available (i.e., the feature has been withdrawn from release),

e) No corresponding booking found (i.e., no record of contract is showing),

f) Key distribution system not available (part of the system 140 is offline).

Alternatively, an unsuccessful key request may occur because the exhibitor system 160 may have timed out while waiting for a response, which may happen if the key provider system 140 is overloaded, offline, out-of-business, or if the key source information is incorrect.

If any of the key distribution systems 140 has responded with a reason why keys could not be obtained, they may be summarized and presented to the operator of exhibitor system 160. Suggested courses of action (e.g., corresponding to the list of reasons above) may also be provided as follows:

a) contact studio or content distributor for keys, then retry,

b) register the SMS with the studio and key distributor(s), then retry,

c) try again, after the suggested time,

d) contact studio and arrange a booking, then retry,

e) contact studio and arrange a booking, then retry,

f) try again later.

Key acquisition process 700 then concludes at step 730.

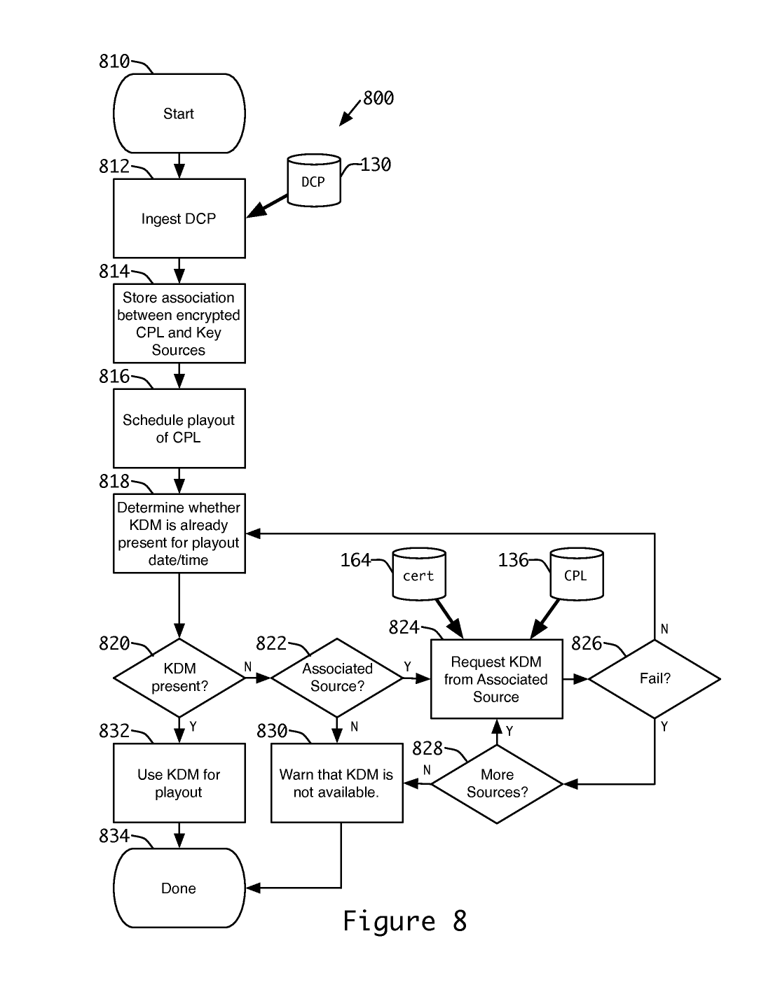

FIG. 8 illustrates a process 800 for tracking key sources for an encrypted CPL. The key source tracking process 800 begins at step 810, with an exhibition system or theater ready to accept a DCP, e.g., DCP 130. At step 812, the system ingests DCP 130, which provides it with not only the content of an encrypted feature, but the key source indicators (e.g., similar to indicators 422, 522, 622 in FIGS. 4-6) for the corresponding CPLs.

At step 814, the association between an encrypted CPL 136 and each corresponding key source indicator is stored in a memory 165 associated with the screen management server 162 or memory 167 associated with the theater management system 166. Redundancies or duplicative information can be eliminated (as may expired or out-of-date information).

At step 816, a showing of the feature represented by encrypted CPL 136 is scheduled, i.e., the feature is directed to play at a certain time on a certain digital cinema server 162. The scheduling task may be performed with either the theater management system 166 or digital cinema server 162. If needed, at least the asset track files 138 and CPL 136 are transferred to the digital cinema server 162 in advance of the schedule showing time.

At step 818, a determination is made as to whether a KDM is already present for the scheduled feature to play at the designated time on the chosen digital cinema server 162. If at step 820, the system finds that the KDM is in fact already available, then at step 832, that KDM is used to decrypt the feature for play out as scheduled, and the process concludes at step 834.

However, if, at step 820, the system detects no KDM for the scheduled feature, then at step 822, a check is made for key sources associated with the designated CPL (based on associations stored in memory at step 814). If no key sources are associated with the scheduled CPL, then the appropriate warning of missing keys or KDMs is made at step 830, and the process ends at step 834.

If it is determined, at step 822, that there is at least one key source associated with the CPL, a loop begins at step 824 in which keys or KDMs are requested from an associated key source, as described with respect to step 718 above. If at step 826, the request for keys is successful, the loop exits and the KDM obtained is checked by branching back to step 818. Otherwise, when the request for keys fails, the loop iterates to the next source at step 828 and attempts to obtain the KDM with the next source at step 824. If, at step 828, no more key sources are known, the loop exits to step 830 and issues a warning that no keys are available. The process ends at step 834.

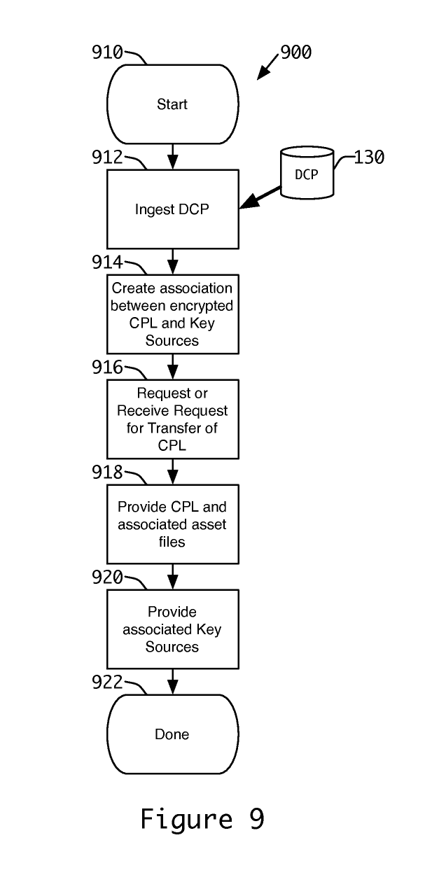

FIG. 9 shows a process 900 for tracking an association between a CPL and key sources, and providing both to another device. This process may be executed by theater management system 166 to provide content to a digital cinema server 162 under its management, or by a first digital cinema server 162 providing content to a second digital cinema server 162.

Process 900 begins at step 910 where a first server (e.g., theater management system 166, or a digital cinema server 162) is prepared to ingest a DCP of the present invention (e.g., DCP 130). At step 912, the first server ingests the MT 130, and is able to parse through the asset map 132, packing list (PKL) 134, composition playlist(s) (CPL) 136, asset track files 138, and (if present) key source file 139. In an alternative embodiment, rather than a complete ingest (which may include computing checksums and digests of very large files to ensure that the files are both uncompromised and error-free), at step 912, the DCP 130 may be merely mounted onto the first server with only a few files (e.g., asset map 132 expected to contain key source indicators) being read to look for key source indicators associated with encrypted CPLs.

At step 914, a record is created for each association between encrypted CPLs and key sources identified in DCP 130. At step 916, a request is received by the first server to transfer CPL 136 to a second server (e.g., a digital cinema server 162 different from the first). Alternatively, the first server can request and/or initiate a transfer of the CPL to the second server without waiting for a request from the second server.

At step 918, in response to the request, CPL 136 and the associated asset track files 138 are transferred to the second server. At step 920, the key source indicators associated with the transferred CPL 136 are supplied to the second server, such that the second server has sufficient information to request keys necessary for the play out of the CPL 136 in advance of whenever they are needed. At step 916, a transfer may be requested by either the first or second server, in which case, the recipient of the request (the second or first server) can perform the transfers of steps 918 and 920. If at step 916, the transfer is initiated by the first server without a request from the second server, then the first server can perform the transfers in steps 918 and 920. After completing the transfer at step 920, process 900 concludes at step 922.

Note that for step 914, in those embodiments where the key source information is embedded in the CPL 136, the association between CPL 136 and at least one key provider system 140 is implicitly provided within the CPL. Likewise, for step 920, the provision of the associated key source indicators is implicit in step 918 where the CPL 136 with the embedded key source information is provided.

Thus, process 900 allows a theater management system 166 or a first digital cinema server to have ingested a DCP 130, but at a later time, transfer at least one specific CPL 136 and the associated asset track files 138 to a second server for play out, along with the associated key source indicators. In this way, only the CPLs of interest (and the asset track files 138 identified therein) need to be transferred to the second server, which is often substantially more efficient than transferring the entire DCP 130, but still enabling the second server to obtain keys from appropriate sources, e.g., using the portion of process 700 beginning at step 718.

While the foregoing is directed to various embodiments of the present invention, other embodiments of the invention may be devised without departing from the basic scope thereof. For example, one or more features described in the examples above can be modified, omitted and/or used in different combinations. Thus, the appropriate scope of the invention is to be determined according to the claims that follow.

1. A digital cinema package, comprising:
key source information relating to at least one source of a decryption key for decrypting content in the digital cinema package.

2. The digital cinema package of claim 1, wherein the key source information is provided in at least one file in the digital cinema package.

3. The digital cinema package of claim 1, wherein the file has a format compliant with existing standards.

4. The digital cinema package of claim 1, wherein the key source information is provided in a file selected from at least one of: an asset map, a packing list, a composition play list and an asset track file.

5. The digital cinema package of claim 1, wherein the key source information indicates at least one location of the decryption key and a method of obtaining the decryption key.

6. The digital cinema package of claim 1, wherein the key source information is provided as text comprising at least one uniform resource locator.

7. The digital cinema package of claim 6, wherein the at least one uniform resource locator identifies at least one of: an email address, phone number, file transfer protocol server, and hypertext transfer protocol server.

8. A method of providing decryption key information for digital cinema content, comprising:
providing key source information relating to at least one source of a decryption key for decrypting content in a digital cinema package, the key source information being provided in the digital cinema package.

9. The method of claim 8, further comprising:
providing the key source information in at least one file in the digital cinema package.

10. The method of claim 9, further comprising:
providing the file in a format compliant with existing standards.

11. The method of claim 9, further comprising:
providing the key source information in the file selected from at least one of: an asset map, a packing list, a composition play list and an asset track file.

12. The method of claim 8, wherein the key source information indicates at least one location of the decryption key and a method of obtaining the decryption key.

13. The method of claim 8, further comprising:
providing the key source information as text comprising at least one uniform resource locator.

14. The method of claim 13, wherein the at least one uniform resource locator identifies at least one of: an email address, phone number, file transfer protocol server, and hypertext transfer protocol server.

15. The method of claim 8, wherein the key source information an digital cinema package are provided to a first server, the method further comprising the steps of:
selecting a composition playlist of the digital cinema package, the composition playlist identifying at least one asset track file in the digital cinema package;
transferring the selected composition playlist and the at least one asset track file from the first server to a second server; and,
transferring the key source information from the first server to the second server for use in retrieving the decryption key for decrypting content corresponding to the composition play list.

16. The method of claim 15, wherein the composition play list comprises the key source information.
